(19) United States
(12) Patent Application Publication
(10) Pub. No.: US 2025/0259005 A1
(43) Pub. Date: Aug. 14, 2025

(54) DATASET PARSING AND SEARCHING METHOD AND SYSTEM

(71) Applicant: Royal Bank of Canada, Toronto (CA)

(72) Inventors: Jacquelyn Zhu DU, New York, NY (US); Amirreza OGHBAEE, New York, NY (US); Marat KHANDROS, New York, NY (US)

(21) Appl. No.: 19/054,570

(22) Filed: Feb. 14, 2025

Related U.S. Application Data
(60) Provisional application No. 63/553,490, filed on Feb. 14, 2024.

(51) Int. Cl. G06F 40/30; G06F 40/205

(52) U.S. Cl. CPC G06F 40/30; G06F 40/205

(57) ABSTRACT

Methods, systems, and techniques for data searching and querying. A query for retrieving information is received, the information corresponds to a subset of data comprised in a dataset. A response to the query is generated, comprising the information retrieved from the dataset using a series of machine learning models configured to parse datasets. The generating comprises: processing the query; generating an instruction for parsing the dataset according to the processing; and parsing the database using the instruction to return the information. Semantic context for the query can be determined using a machine learning model. Search results determined by parsing the database can be translated into natural language using a large language model. The instructions and search results can be evaluated using one or more arrays of large language models.

### CROSS REFERENCE TO RELATED APPLICATIONS

The present application claims priority to and benefit of U.S. provisional patent application No. 63/553,490, filed on Feb. 14, 2024, and entitled “DATASET PARSING AND SEARCHING METHOD AND SYSTEM”, the entirety of which is hereby incorporated by reference herein.

### TECHNICAL FIELD

The present disclosure is directed at methods, systems, and techniques for data parsing and searching using multiple large language models.

### BACKGROUND

Analysing data is an important aspect of many business processes. For example, data analysis is critical for identifying and solving issues arising through operations and providing insight on underlying causes of incidents. However, data analysis relies heavily on parsing and searching through datasets which is a computationally challenging problem particularly when the datasets are large or complex in nature. Dataset search tools have previously been developed to assist with dataset analysis, however such tools involve complicated syntaxes and technical nuances requiring training for users to use dataset search tools effectively. In addition, several different search tools may be required to conduct dataset analysis, which may not be compatible with one another. Accordingly, there is a need for skills-agnostic dataset analysis methods and systems.

### SUMMARY

In accordance with one aspect of the present disclosure, a method for searching and parsing a dataset is disclosed, the method comprising: receiving, at a pre-trained query judge large language model, computer readable instructions for querying the dataset, wherein the computer readable instructions for querying the dataset comprise instructions responsive to an input question, wherein the input question is a data-related natural language question; performing a first function using the pre-trained query judge large language model in accordance with a first query prompt, wherein the first function comprises a first assessment of the computer readable instructions for querying the dataset, and providing a first evaluation; determining, using one or more search functions executed on the dataset, a data response to the input question using the computer readable instructions for querying the dataset; receiving, at a pre-trained translation large language model, the data response to the input question; performing a second function using the pre-trained translation large language model in accordance with a first translation prompt, wherein the second function comprises translating the data response to the input question into a natural language response to the input question; receiving, at a pre-trained translation judge large language model, the natural language response to the input question; performing a third function using the pre-trained translation judge large language model in accordance with a second translation prompt, wherein the third function comprises a second assessment of the natural language response to the input question, and providing a second evaluation; and providing a natural language answer to the input question, wherein the natural language answer is responsive to the natural language response to the input question and the second evaluation.

In some aspects, the method further comprises: receiving, at a pre-trained query large language model the input question; (b) performing a fourth function using the pre-trained query large language model in accordance with a second query prompt, wherein the fourth function comprises translating the input question into the computer readable instructions for querying the dataset.

In some aspects, the first assessment comprises assessing the computer readable instructions for querying the dataset for at least one of: conciseness, correctness, or accuracy.

In some aspects, the second assessment comprises assessing the natural language response to the input question for one or both of coherency or language conciseness.

In some aspects, the method further comprises: receiving and storing one or more previous natural language answers to one or more previous input questions; receiving, at a previous queries search module, the input question; executing a semantic search of the previous natural language answers using the previous queries search module; and providing one of the one or more natural language answers to one or more previous input questions which is responsive to the input question.

In some aspects, the method further comprises: iteratively improving the natural language response to the input question using the pre-trained translation large language model in response to the second evaluation.

In some aspects, the method further comprises: iteratively improving the computer readable instructions for querying the dataset using the pre-trained query large language model in response to the first evaluation.

In some aspects, the method further comprises: receiving, at a pre-trained natural language processing model, the input question; executing a semantic search on the dataset responsive to the input question using the pre-trained natural language processing model; and receiving, at the pre-trained query large language model, a search result from the pre-trained natural language processing model.

In some aspects, the semantic search comprises a k-nearest neighbor search.

In some aspects, the input question is received via an application programming interface.

In some aspects, the input question is received via textual chat interface.

In accordance with another aspect of the present disclosure, a dataset searching method is disclosed, comprising: receiving a query for retrieving information, wherein the information corresponds to a subset of data comprised in a dataset; generating a response to the query comprising the information retrieved from the dataset using a plurality of machine learning models; the generating comprising: processing the query to generate an instruction for parsing the dataset; parsing the database according to the instruction to return the information; and generating the response using the information; the plurality of machine learning models are respectively configured to: generate the instruction according to the query; evaluate the instruction; generate the response from the information; and evaluate the response.

In some aspects, the plurality of machine learning models comprises: a first large language model (LLM) configured to generate the instruction according to the query; a first array of LLMs configured to evaluate the instruction; a second LLM configured to generate the response form the information; and a second array of LLMs configured to evaluate the response.

In some aspects, the parsing comprises processing the instruction using a search executor configured to search the dataset to return the information.

In some aspects, the query is a natural language query, and the processing comprises determining semantic context in the query, the semantic context corresponding to a relationship between the query and the data comprised in the dataset.

In some aspects, the semantic context comprises a data field of the subset of data, a data type of the subset of data, a data source of the subset of data, a description of the subset of data, or combinations thereof.

In some aspects, the plurality of machine learning models further comprises a natural language processing (NLP) model configured to determine the semantic context.

In some aspects, the determining comprises performing a K-nearest neighbor search on embeddings of the dataset.

In some aspects, the method further comprises generating the embeddings from the dataset.

In some aspects, the generating of the instruction comprises inputting the semantic context to the first LLM.

In some aspects, the instruction is generated according to a template comprising: placeholders for the semantic context, a system prompt for the first LLM corresponding to the instruction, rules for the instruction, context for the instruction, background for the instruction, or combinations thereof.

In some aspects, the first array of LLMs comprises a formatting LLM configured to evaluate a format of the instruction, a correctness LLM configured to evaluate a syntax of the instruction and an alignment of the instruction to the query, an accuracy LLM con-figured to evaluate a compliance of the instruction to semantic context, or combinations thereof.

In some aspects, the evaluating of the instruction comprises processing the instruction using each LLM in the first array of LLMs, wherein each LLM either accepts or rejects the instruction; rejecting the instruction comprises outputting, by a corresponding LLM in the first array of LLMs, one or more reasons for rejecting the instruction; and the generating of the instruction further comprises iteratively generating the instruction until each LLM in the first array of LLMs accepts the instruction, where-in each successive instruction is generated by the first LLM according to the one or more reasons for rejecting the instruction.

In some aspects, the first array of LLMs is implemented using LangChain and inherits the StringEvaluator class.

In some aspects, the search executor is an ElasticSearch executor.

In some aspects, the instruction is generated as computer readable search string code compatible with a search executor configured to search the dataset by the first LLM; and the parsing comprises: processing the instruction using the search executor to parse the dataset to retrieve the information corresponding to the subset of data.

In some aspects, the subset of data is translated into the response by the second LLM; and the response is a natural language response to the query comprising the subset of data.

In some aspects, the second array of LLMs comprises a coherency LLM configured to evaluate natural language coherency of the response, a conciseness LLM configured to evaluate natural language conciseness of the response, or both.

In some aspects, the evaluating of the response comprises processing the response using each LLM in the second array of LLMs, wherein each LLM either accepts or rejects the response; rejecting the response comprises outputting, by a corresponding LLM in the second array of LLMs, one or more reasons for rejecting the response; and the generating of the information further comprises iteratively generating the response until each LLM in the second array of LLMs accepts the response, wherein each successive response is generated by the second LLM according to the one or more reasons for rejecting the response.

In some aspects, the method further comprises: storing the query and the response as embeddings in a vector database storing a plurality of queries and a plurality of responses corresponding thereto; receiving a second query for retrieving second information; performing a semantic context search of the second query on the plurality of responses stored in the vector database using a NLP model to determine a relevant query from the plurality of queries for retrieving the second information; and returning a second response corresponding to the relevant query.

In some aspects, the query is received via an application programming interface or a textual chat interface.

In accordance with another aspect of the present disclosure, at least one non-transitory computer readable medium having stored thereon computer program code that is executable by at least one processor is disclosed, which, when executed by the at least one processor, causes the at least one processor to perform method of any one of the above aspects.

In accordance with another aspect of the present disclosure, a system is disclosed, comprising at least one processing unit configured to perform the method of any one of the above aspects.

### BRIEF DESCRIPTION OF THE DRAWINGS

These and other features of the invention will become more apparent from the following description in which reference is made to the appended drawings wherein:

FIGS. 1 and 2 depict representations of machine learning model agents, according to example embodiments.

FIG. 3 depicts a computing device for implementing the machine learning model agents of FIGS. 1 and 2, according to an example embodiment.

FIG. 4 depicts a method for performing dataset searching, according to an example embodiment.

FIG. 5 depicts a system for implementing the dataset searching method of FIG. 4, according to an example embodiment.

### DETAILED DESCRIPTION

The first and most crucial step in incident resolution is root cause analysis, which relies heavily on parsing through various datasets, monitoring tools, and logs. Manual dataset analysis and parsing to identify root causes of incidents is not feasible and, depending on how the dataset is stored and on the nature of the dataset, may not be possible. Existing dataset search solutions utilize complex syntax and technical nuances, preventing consumers of different technical skill levels from effectively utilizing existing solutions. Prompt resolution of incidents can be critical for organizations to maintain their reputation and guarantee client satisfaction. Data analysis may also be required at an organizational level for executive reviews, risk analysis, and governance purposes. Such analysis typically involves technical nuances associated with data search tools and complex search queries. Further, searching of large, complex, and technical datasets can be computationally intensive and may require the use of a number of different tools with varying and often complex syntaxes.

Large language models (each an “LLM”) have been implemented to provide a chatbot-type interface to allow consumers of different technical skill levels to ask questions in natural language related to one or more underlying datasets. Whilst LLMs are capable of effectively providing qualitative answers to the aforementioned questions, generative artificial intelligence models including LLMs have previously been ineffective at providing accurate answers to questions requiring the analysis of quantitative datasets due to their lack of verification, which can be problematic for LLMs in particular given their propensity to “hallucinate” seemingly correct outputs. Furthermore, data analysis may require parsing through various large datasets with different structures and data source types. A diversity of datasets makes training LLMs for particular datasets computationally expensive.

The present disclosure can provide systems and methods for providing data-related queries by navigating through one or more data sources. The data related queries may be questions having appropriate responses based on a subset of data comprised in one or more data sources. For example, a query may inquire about the price of a good on a particular date where the correct response can be determined from a dataset comprising prices of a plurality of goods over a period of time. Each data source may comprise a dataset, which may be stored for example in a database. A dataset may comprise tabular data (e.g. a spreadsheet), a plurality of data value pairs, or a plurality of data fields each containing data corresponding thereto.

The present disclosure can be implemented using a series of machine learning models, neural networks, artificial intelligence models, etc. In particular, an array of LLMs can be employed by an agent LLM, along with added context through semantic search. In some embodiments, the only required input for training is contextual information from data sources corresponding to datasets that need to be searched. The disclosed systems and methods can translate any given human questions (e.g. natural language) into efficient technical queries (e.g. with proper syntax validation) required for answering that question. Finally, an accurate quantitative answer can be generated in natural language using the returned data as the underlying context. Note that the present disclosure can be data agnostic and can handle various data source types without extra training.

Systems and methods that can learn intrinsically different datasets in short time frames (e.g. minutes) can be invaluable in various scenarios. Prompt resolution of incidents can be critical for financial services to maintain their reputation and guarantee client satisfaction. As noted above, the a crucial step in incident resolution is root cause analysis, which relies heavily on parsing through various datasets. By providing a systems and methods that can respond to queries quickly and easily (e.g. through the use of a live chat interface), operation teams can quickly and effectively receive answers to pressing questions in live scenarios. By utilizing LLMs, particularly multimodal LLMs, the present disclosure can facilitate smooth conversations with a chat interface for information retrieval with intelligent data navigation in the background. Further, the present disclosure can clarify answers and even help users ask the right questions.

As one example, the present disclosure can be applied to IT Service Management (ITSM) datasets, specifically Incident, Problem, and Change. In the Site Reliability Engineering (SRE) team, various Technology Infrastructure (TI) datasets are utilized. These datasets can be helpful in many different scenarios. For example, a concrete ITSM-related dataset is available via an Elasticsearch™ (ES) search engine and its user interface, Kibana™. However, getting answers to simple questions can be daunting due to these tools' complicated syntax and technical nuances. Operation teams can require need immediate answers to questions like “Were there any high-risk enterprise changes implemented in the last few days for application XYZ?” when dealing with high-priority incidents, which would require highly technical dataset searching. Leveraging a chatbot that can answer any TI-related questions can facilitate the discovery of the root cause and yield a quicker resolution. As such, the present disclosure can provide a robust multimodal approach for searching datasets.

Accordingly, the present disclosure can provide an alternative to monitoring tools as users can get answers to their specific questions in seconds. Most users often rely on monitoring dashboards and static reports to learn about their applications. While a long list of limitations is associated with each, by utilizing the present disclosure, users can inquire about their specific metrics and instantly get the desired results without any prior technical knowledge about underlying data sources.

Various advantages are possible by means of the present disclosure. Enterprise Problem and Change statistics, requiring the parsing of datasets, can be useful in executive reviews, risk analysis, and governance purposes. The present disclosure can increase the speed of insight discovery by reducing toil in data nuances or complex queries. The present disclosure can also create new opportunities by giving business users easy access to complex data analysis. The present disclosure can broaden user engagement and observability as the present disclosure can be a unique skills-agnostic technical solution for dataset parsing. The abstraction level employed in the present disclosure can also make integration of the disclosed systems and methods with existing platforms and datasets smoother and can provide a critical blueprint for generalizing and scaling to other data sources. The present disclosure can also provide an LLM orchestration agent that is capable of comprehending new datasets. As the models comprised therein may be pre-trained, the disclosed systems and methods can answer complex questions on a new dataset right after getting the contextual input without any extra steps. A powerful tool such as the disclosed systems and methods can reduce toil across organizations and alleviate the workloads of associates needing different tools to answer business questions.

At least some embodiments herein are accordingly directed at a method and system for data analysis and data parsing utilizing multiple pre-trained LLMs to enable users of different technical skill levels to efficiently obtain accurate quantitative answers to user posed questions directed to different datasets without requiring intensive LLM training specific to particular datasets. In at least some embodiments, a large language model agent is provided comprising multiple LLMs, each being pre-trained and subsequently initialized by a use case specific prompt, such that each LLM is configured to perform at least one of, and in some embodiments exactly one of: a query generation function, a translation function, and a judge function, on one or more datasets without requiring further training on said dataset. The LLMs provided herein are thus modular, enabling the utilization of the same model design with any given new data source without additional training or fine-tuning. The large language model agent provided herein further comprises one or more natural language processing models. Accordingly, the large language model agent is configured to: translate a user provided question, written in natural language, into the most efficient technical queries with proper syntax validation required for answering the question; iteratively evaluate the results of the technical query translation; execute a search function on a dataset provided; translate the resulting technical data-related answer into natural language; iteratively evaluate the results of the answer translation; and provide a user with a generated simple natural language answer to the posed data-related technical question using the returned data as the underlying context.

In at least some embodiments, a chatbot is provided for user interaction with the large language model agent, such that the implementation allows live chat capability for users of different technical skills to quickly obtain answers to questions requiring complex searching and parsing of a dataset via a conversational question and answer approach. The large language model agent provided herein is capable of searching and parsing datasets of various formats and complexities without further training, as each LLM component of the agent is pre-trained. Such transferability allows the agent disclosed herein to answer complex questions on a new dataset without requiring any further training and without requiring any extra steps such as fine tuning. In at least some embodiments provided herein, the agent comprises multiple LLMs such that each LLM is initialized using a use case specific prompt, providing for increased accuracy for the function each LLM is initialized to perform and further increasing the accuracy of the agent overall. In addition, in accordance with an embodiment described herein, the agent comprises multiple LLMs initialized to judge responses provided (e.g. a translation provided by an LLM into natural language) and iteratively improve the response via a feedback loop with two or more LLMs in connection with one another, such that the overall answer provided to the user has a high degree of technical accuracy in combination with a sufficiently clear natural language explanation. The aforementioned iterative feedback loop also enables model self-healing, such that one or more LLMs will monitor the input provided and the resulting output to continuously learn and improve querying capabilities of the agent. In at least some embodiments, the feedback loop comprises a judge LLM providing and storing reasoning following assessment of the output of a prior LLM. The prior LLM receives the stored reasoning prior to providing a subsequent updated output.

As such, aspects of the present disclosure can include:
1. Use of an orchestration agent to implement an “omniscient” chatbot capable of answering quantitative technical questions. An orchestration agent can allow other models to be trained for niche tasks, providing better overall accuracy.
2. Use of pre-processing NLP models to leverage classic NLP approaches. This approach can guarantee the most accurate prompt generation for downstream models (e.g. LLMs). As a result, users can ask questions in any format without worrying about prompt optimization, as their questions will be translated into suitable prompt formats before input to the LLMs.
3. Use of internal evaluator machine learning models can provide extra efficiency in complex data parsing among existing datasets, resulting in quick and accurate responses. Moreover, a self-healing model can be used to monitor the queries and their syntax to continuously learn and improve response generation.

In contrast to other dataset searching approaches, the present disclosure utilizes a series of LLMs to tackle dataset searching. A multi-step approach starting with classic natural language processing (NLP) models (e.g. via use of embedding, vectorizing, etc.) and ending with additional evaluators can enable the present disclosure to outperform traditional machine learning approaches in performing dataset searching. Further, generative artificial intelligence bots are not generally used for answering quantitative questions due to their lack of data verification. The present disclosure can be implemented using additional LLMs solely designed for evaluation purposes. A self-healing model can also be utilized to optimize the technical queries before passing them to the data sources. Moreover, a pre-trained LLM can translate the quantitative response (e.g. raw data retrieved from the dataset) back to match with the context of the inputted question in natural language.

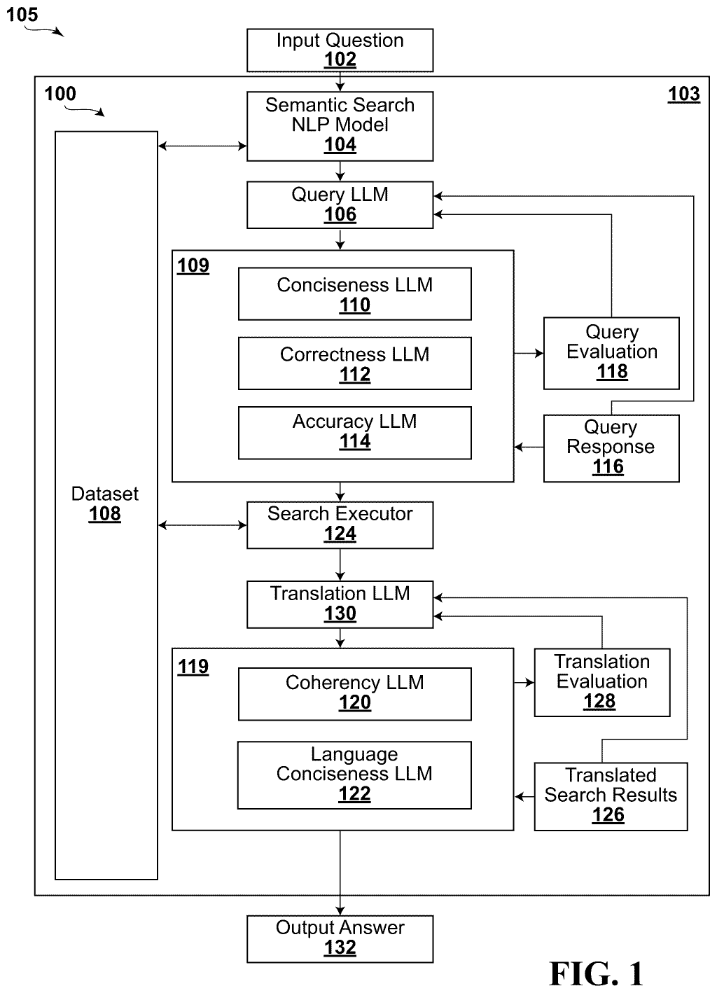

Referring now to FIG. 1, there is shown a block diagram of a computing device in which one or more technologies or methodologies can be implemented, such as, for example, analysing data and providing a natural language quantitative answer with high accuracy in response to a natural language question provided to a large language model agent. In an embodiment, the computing device includes a processor, computational circuitry, and one or more large language models configured to assist in interfacing with one or more datasets.

In an embodiment, the computing device is configured to provide a large language model agent 100 in accordance with an embodiment in which the agent 100 is configured for receiving an input question 102 as input and outputs an output answer 132. The input question 102 can be a query and the output answer 132 can be a response to the query. It will be understood that FIG. 1 represents large language model agent 100 as data components and executable components stored within one or more storage devices 103 of a computing device 105, in accordance with an embodiment. The various components in FIG. 1 that perform actions may be expressed as computer program code that is executable by at least one processor (not shown) of the computing device.

In an embodiment, input question 102 comprises a natural language data-related question related to one or more datasets, such as dataset 108. In particular, the input question 102 can have a response that may be determined by searching through one or more datasets. The response (e.g. the output answer 132) can therefore include a subset of data from the dataset 108. That is, information required for providing the output answer 132 can be determined by parsing or searching one or more datasets. Note that the dataset 108 is provided herein as an example of a data source and that alternative data sources such as databases, logs, etc. are possible as well. To determine the output answer 132, the agent 100 processes the input question 102 using a series of machine learning models.

In an embodiment, input question 102 is provided to semantic search NLP model 104, comprising a natural language processing (hereinafter “NLP”) model configured to translate natural language input question 102 into computer readable format using machine learning methods for natural-language understanding. Semantic search NLP model 104 comprises an NLP model pre-trained using methods known in the art. In an embodiment, semantic search NLP model 104 is the pre-trained ‘all-MiniLM-L6-v1’ model from Hugging Face™. In an alternative embodiment, semantic search NLP model 104 comprises the pre-trained ‘text-embedding-ada-002’ model of OpenAI™.

Dataset 108 comprises one or more aggregations of data in a defined format. In an embodiment, the format of dataset 108 may comprise a structured query language (hereinafter “SQL”) database, a non-structured query language (hereinafter “NoSQL”) database, an Elasticsearch™ (Trademark of Elasticsearch BV) database, a Splunk™ database (Trademark of Splunk Inc.), an Apache™ Hadoop database, or the like. In an embodiment, dataset 108 may comprise a dataset of attribute-value pairs and arrays in JavaScript Object Notation (hereinafter “JSON”) format, wherein each field comprises a field name, a datatype, and a brief description of the data contained within the field.

In an embodiment, embeddings are created from data contained within dataset 108, for example using a ‘.encode( )’ method for the relevant field of the data within dataset 108. In an embodiment, Elasticsearch™ (Trademark of Elasticsearch BV) is utilized as a vector database, wherein the created embeddings are stored as dense vectors alongside other relevant fields. Other implementations of the vector database are possible as well, such as with Chroma™, Redis™, Postgres™, etc. The vector database can be a vector representation of the dataset 108 and can be used to provide semantic context for the data comprised in the dataset 108, which can facilitate machine learning models in interpreting the dataset 108. In an embodiment, the vector database is separate from the dataset 108. That is, the vector database and the dataset 108 can be searched separately. For example, a semantic search can be performed on the vector database (as described herein) to return semantic context which can be input to machine learning models to facilitate output generation. A conventional data search can be performed on the raw dataset 108 to return raw data values. Alternatively, the vector database is utilized as the dataset 108 (e.g. as a representation of the dataset 108) for the purpose of searching for the subset of data and/or semantic context searching, where the search results can be converted from embeddings to the original data values and/or natural language.

In an embodiment, a semantic search of dataset 108 is performed by semantic search NLP model 104 using input question 102. In particular, the semantic search can be performed on the vector database comprising vector representations of the dataset 108 to determine semantic context for the input question 102. The semantic context can correspond to the input question 102, for example representing a relationship between the query (e.g. input question 102) and data within the dataset 108. That is, the semantic context can provide relevant data field, relevant data type, relevant data source, relevant description, etc. for determining an appropriate response to the input question 102. The semantic context can also correspond to the subset of data pertinent to generating a response to the input question 102, which may be useful in providing context (e.g. to guide or restrict) the searching of the dataset 108 to ensure that the search is relevant (e.g. can return relevant results) to the input question 102. For example, the semantic search can provide the most relevant datasource(s) and data field(s) of a subset of data contained within dataset 108.

In an embodiment, a K-nearest neighbor (hereinafter “KNN”) search algorithm is implemented by semantic search NLP model 104 to query a pre-defined number of top closest results from created embeddings of data within dataset 108, wherein closeness is measured as containing all the necessary fields of dataset 108 required to provide the data necessary to answer input question 102. In an embodiment, a KNN search algorithm is implemented by semantic search NLP model 104 using Elasticsearch™ (Trademark of Elasticsearch BV), wherein dataset 108 comprises dense vector fields. Note that the semantic search method corresponds to the implementation of (e.g. suitable for searching) the vector database. In at least some embodiments, the pre-defined number of closest results is determined utilising a testing procedure in which successive values of N, being the pre-defined number of closest results, are iteratively tested to determine whether for a given value of N all necessary fields of data are returned across a set of input questions (e.g. input question 102) which vary in complexity both in terms of the number of fields required to answer the question and the vagueness of the question. Semantic search NLP model 104 is configured to provide query LLM 106 the pre-defined number of closest data fields and associated embedded data required to quantitatively answer input question 102. By way of an example, in response to input question 102 “How many major incidents occurred over the weekend in Q1 of fiscal year 2021-2022?”, semantic search NLP model 104 may return a partial result of:

```
[
  {
    ‘field_name’: ‘proposed_on’,
    ‘type’: ‘date’
    ‘description’: ‘after the incident has started, this is the datetime in
    which the
    incident is proposed to be a major incident’
  },
  {
    ‘field_name’: ‘state’,
    ‘type’: ‘text’
    ‘description’: ‘current status of incident’
  },
  {
    ‘field_name’: ‘child_incidents',
    ‘type’: ‘long’
    ‘description’: ‘number of child incidents that stem from this incident’
  },
  {
    ‘field_name’: ‘description’,
    ‘type’: ‘text’
    ‘description’: ‘description of incident details'
  }
]
```

A subset of the returned result is provided for brevity, however it will be understood that the returned result may comprise a pre-defined number of fields based on input question 102 and dataset 108. In the above example, the returned semantic context comprises a data field, a data type, and a data description. In particular, the semantic context search determined that the subset of data relevant for responding to the input question 102 can include a time of incidents (‘proposed_on’), a status of the incident (‘state’), a number of subsequent resulting incidents (‘child_incidents’), and a description of the incident (‘description’). Accordingly, the semantic context returned the data field, data type, and data description for the subset of data.

The agent 100 also comprises a query LLM 106. The query LLM 106 comprises a LLM which, having been pre-trained using LLM training methods known to the art, is provided at least one query prompt. Query prompts comprise one or more pre-defined prompts configured to initialize one or more LLMs to perform a function. Query prompts are customized to the use case of large language model agent 100. At least in some embodiments, query prompts provide query LLM 106 with the role of query LLM 106, the expected output, examples of expected outputs, and rules to follow. Each query prompt can comprise the input questions 102 as well as the semantic context determined by the NLP model 104. The query LLM 106 can process the query prompts to output a query response 116. The query response 116 can correspond to an instruction for searching the dataset 108 in order to return the subset of data required for responding to the input question 102. The instruction should be in a format, syntax, or structure accepted by a search engine or executor 124 configured to search the dataset 108. For example, the instruction can be in natural language for a crawler-type search engine. In some embodiments, the search is performed on the vector database as the dataset 108. Accordingly, the search executor 124 may be an ElasticSearch™ query executor. Therefore, the instruction can be computer-readable code (e.g. search code string) that is compatible with and in the proper syntax for the ElasticSearch™ query executor.

In particular, the pre-defined prompts can be generated according to one of a plurality of prompt templates. Each template can provide additional context, rules, and background to the query LLM 106 for understanding the input question 102 and the query response 116 to be generated. The role of the query LLM 106 can be defined using a system prompt which can provide the query LLM 106 with background and context for interpreting the input question 102 and for generating the query response 116. For example, a system prompt can comprise a high level description of the task that the query LLM 106 needs to perform, such generating instructions for a particular search executor. The semantic context and the input question 102 can be incorporated into the query prompt using (e.g. by replacing) pre-defined placeholders.

By way of an example, the following query prompts may be provided to query LLM 106 in an embodiment, shown as a template:

template=
“You are a helpful assistant who is an expert at coding in Elasticsearch
DSL. The following”
“question will use the ‘pico-inc’ index which contains information about
incidents. Here is”
“a list of dicts of index fields to consider, which contains the field name,
ES field type, and a”
“description of the field: {context}.”
“Some tips on ES: all text fields also have a keyword type associated. Use
the”
“keyword only when filtering on a text field, and not for any other fields.
Date and long fields”
“have doc values enabled for script queries. Aggregations requires the
search api but consider if”
“the documents need to be returned or if size can be 0. If more than one
value can match for a”
“given field, consider if this requires separate filters where all of the
values must match, or”
“one terms filter where any of the values would satisfy the query.”
“Task: Take the following question and translate it into an Elasticsearch
query: {question}.”
“Requirements: Make sure the fields are of the right type using the above
context.”
“Construct the query as simple as possible while answering the question
completely.”
“Return the answer using the below example format with no other text:”
“GET pico-inc/_count”
“{{“
“\”query\”: {“
“ \”term\”: {{“
“ \”example_field.keyword\”: \”example_value\””
“ }}”
“ }}”
“}}”
“If you are unsure, please return ‘I am not sure, can you specify more
details?”
“Note that when the user asks for a query on a fiscal year, the fiscal year
starts on Nov 1st”
“for each year, so use absolute ranges in these range queries. Weekends
are Saturday and Sunday”
“and can be found using a script query. Use ‘opened_at” field unless the
question asks for a”
“datetime field that matches the context.”

In the above example, “You are a helpful assistant who is an expert at coding in Elasticsearch DSL The following question will use the ‘pico-inc’ index which contains information about incidents” corresponds to the system prompt; “{context}” and “{question}” correspond to placeholders to be replaced with the semantic context and input question 102, respectively; “Make sure the fields are of the right type using the above context”, “Return the answer using the below example format with no other text”, and “Note that when the user asks for a query on a fiscal year, the fiscal year starts on Nov 1st” correspond to rules for the query response 116; and “all text fields also have a keyword type associated. Use the keyword only when filtering on a text field, and not for any other fields. Date and long fields have doc values enabled for script queries” and “Note that when the user asks for a query on a fiscal year, the fiscal year starts on Nov 1st for each year, so use absolute ranges in these range queries. Weekends are Saturday and Sunday and can be found using a script query. Use ‘opened_at” field unless the question asks for a datetime field that matches the context” correspond to additional context for generating the query response 116.

Query LLM 106 can provide the query response 116 to query judge LLMs 109, comprising a portion of the agent 100. In an example embodiment in which query prompts are provided to query LLM 106 directing query LLM 106 to translate input question 102 into search string code compatible with Elasticsearch™ (Trademark of Elasticsearch BV) to search database 108, the following query response 116 may be provided to query judge LLMs 109:

```
GET pico-inc/_count
{
  “query”: {
    “bool”: {
      “must”: [
  {
  “range”: {
    “opened_at”: {
      “gte”: 2021-11-01T00:00:00”,
        “lt”: “2022-02-01T00:00:00”
    }
  }
},
{
  “terms”: {
    “priority”: [1, 2]
  }
},
{
  “script: {
    “script”: {
      “source”: “doc[‘opened_at’]. value.dayOfweek .= 6”
      }
    }
  }
]
}
}
}
```

Query judge LLMs 109 comprise an array of LLMs configured to evaluate the query response 116 provided by query LLM 106 to judge its accuracy and performance. Existing LLM evaluators are known in the art, such as those exist in the LangChain package. Based on testing, existing methods lack flexibility when judging test cases requiring specific information to attend to. As such, in at least some embodiments, query judge LLMs 109 are a part of one or more customized Classes which inherit the ‘StringEvaluator’ Class from the LangChain package primarily for its ‘evaluate_strings( )’ method, which provides a score and reasoning based on a prompt and input. The customized LLM evaluators of query judge LLMs 109 can provide the ability to customize the criteria as well as the ability to include additional context information in addition to the query response 116, and as such query judge LLMs 109 can be configured to efficiently evaluate query responses resulting from different data sources comprising dataset 108 and for different use cases (e.g. variants of input question 102). Query judge LLMs 109 can be configured to integrate with any programming language and syntax. In at least some embodiments, query judge LLMs 109 are configured specifically for Elasticsearch™ (Trademark of Elasticsearch BV) queries and associated syntax.

In at least some embodiments, query judge LLMs 109 comprise at least three LLMs which each LLM, having been pre-trained using LLM training methods known to the art, is provided at least one query judge prompt. In at least some embodiments, any one or more of the at least three LLMs of query judge LLMs 109 may each comprise an instance of GPT-4 model of OpenAI™ initialized by one or more prompts to perform an assessment function. The LLMs comprised in the query judge LLMs 109 can be implemented in series. In at least some embodiments, query judge LLMs 109 comprise at least formatting or conciseness LLM 110, correctness LLM 112, and accuracy LLM 114. Formatting LLM 110, correctness LLM 112, and accuracy LLM 114 each comprise a LLM, which has been initialized using a prompt of query judge prompts. In an embodiment, Formatting LLM 110 is instructed by query judge prompts to review the query result to ensure the format matches the expected output of the query result responsive to input question 102 without unnecessary detail. In an embodiment, correctness LLM 112 is instructed by query judge prompts to review the query result to ensure the correct queries and syntax are contained within the query result output by query LLM 106. In an embodiment, accuracy LLM 114 is instructed by query judge prompts to review the query result output from query LLM 106 to confirm the proper fields were used based on the provided context and to guarantee the query result matches the business requirements of input question 102.

Each of the three or more query judge LLMs 109 provides a query evaluation 118, being either pass (e.g. accepted) or fail (e.g. rejected), indicating whether the query response 116 complies with the necessary conditions initialized to the respective query judge LLMs 109 by the respective query judge prompts. In at least some embodiments, one or more of the query judge LLMs 109 are instructed to additionally provide an analysis in natural language explaining why the query response 116 either passes or fails the evaluation within the query evaluation 118 output by one or more of the query judge LLMs 109. In an embodiment, query evaluation 118 of the query response 116 must be evaluated as “pass” by each of the three or more query judge LLMs 109. In some embodiments, one or more (e.g. each) of the query judge LLMs 109 can evaluate the query response 116 using a score. The score can comprise a part of the query evaluation 118 and can be a numerical value in a range of values, where a threshold score is used to determine if the query response 116 is evaluated as a “pass” or “fail”. For example, the score can be an integer value between 1 and 10 where a score of greater than 5 is considered a passing score. The query judge prompts can outline the scoring framework as a rule, for example by identifying the valid range of the score and the threshold score. As an example, the query judge prompts can comprise a statement of: “rate the query response using a score from 1 to 10, where 10 is the best possible score and where a score of greater than 5 indicates the query response has passed the evaluation”.

In an embodiment, an iterative loop is formed between query judge LLMs 109 and query LLM 106. In at least some embodiments, if any of the three or more query judge LLMs 109 (e.g. formatting LLM 110, correctness LLM 112, accuracy LLM 114) returns a query evaluation 118 of “fail”, query LLM 106 is instructed to update the query response 116 and provide an updated query response 116 to query judge LLMs 109 for further evaluation. The query LLM 106 can also receive the (failure) analysis (e.g. in the query prompt provided to the query LLM 106) and the score generated by the query judge LLMs 109 in order to improve the query response 116. In an embodiment, the aforementioned feedback process is iterated for pre-defined number of evaluations. In an alternative embodiment, the aforementioned feedback process is iterated until all of the three or more query judge LLMs 109 returns a query evaluation 118 of “pass”.

Each query judge prompt comprises one or more pre-defined prompts configured to initialize the query judge LLMs 109 to evaluate the query response 116. In at least some embodiments, query judge prompts provide query judge LLMs 109 with: the role of query judge LLMs 109, the expected output, examples of expected outputs, and rules to follow. The query judge prompts can comprise the query response 116. In particular, the pre-defined prompts for the query judge prompts can be generated according to one of a plurality of prompt templates. Each template can provide additional context, rules, and background to the query judge LLMs 109 for evaluating the query response 116, for example with regard to the formatting, correctness, and accuracy thereof, as the case may be. The role/task of the query judge LLMs 109 can be defined using a system prompt. The query response 116 can be incorporated into the query judge prompt using (e.g. by replacing) pre-defined placeholders. In an example embodiment, the following judge query prompt is provided to correctness LLM 112:

template = “””
Assuming that the fields and values used are correct, determine if the
assistant's answer contains
valid Elasticsearch syntax that correctly matches the user question. If the
user were to run the
query, evaluate if it would execute successfully and produce a correct
answer.
Assign a score of 1 if the answer satisfies these conditions, and 0
otherwise.
--------
QUESTION: {input}
--------
OUTPUT: {prediction}
--------
Reason step by step about why the score is appropriate, then print the
score at the end. At the end,
repeat the score alone on a new line.
“””

In the above example, “{input}” corresponds to a placeholder to be replaced with the query response 116; “Assuming that the fields and values used are correct, determine if the assistant's answer contains valid Elasticsearch syntax that correctly matches the user question” corresponds to the task performed by the correctness LLM 112; and “Assign a score of 1 if the answer satisfies these conditions, and 0 otherwise” corresponds to rules for evaluating the query response 116.

In the previous example embodiment, correctness LLM 112 having been initialized with the above example query prompts would output the following example response resulting from the assessment of the query response 116 received from query LLM 106, indicating that the query response 116 has passed the evaluation by the correctness LLM 112:

{
‘score’: 1
‘reasoning’: ‘The criteria states that the assistant's response should
contain valid Elasticsearch
syntax that correctly matches the user question. This means, the response
should be able to produce
a correct answer if the query is executed. Looking at the submission, it is a
GET request using
Elasticsearch syntax. It is querying a count from the ′pico-inc′ index. The
“must” clause within the
“bool” query contains three conditions: 1. A “range” condition, which is
checking if the
“opened_at” field is between “2022-11-01T00:00:00” and
“2023-11-01T00:00:00”. This implies
that it is checking for incidents that happened within the fiscal year 2022.
2. A “terms” condition,
which is checking if the “priority” field is either 1 or 2. This can be
inferred as checking for major
incidents. 3. A “script” condition, which is checking if the day of the week
when the incident was
opened is greater than or equal to 6. This implies that it is checking for
incidents that happened
over the weekend. Given the above analysis, it can be concluded that the
assistant's response
matches the user question and is using valid Elasticsearch syntax.
}

Search executor 124 comprises a component configured to receive query response 116 (e.g. once evaluation is passed) and execute a search function on dataset 108. In some embodiments, the search executor 124 can be a search engine or a search algorithm. The search executor 124 can perform the parsing of the dataset 108 to return the subset of data required for responding to the input question 102 in accordance with the instructions outlined in the query response 116. The search executor 116 can search the raw data representation of dataset 108 or the embeddings representation of the dataset 108 comprised in the vector database, as described above. The search results can comprise one or more raw data values or embeddings converted to raw data values. For example, for an input question of “what is the highest price of good A during 2020?”, the search result return from parsing the dataset 108 can be “$500”.

Once the dataset 108 is queried, search executor 124 can provide data-related search results to translation LLM 130 comprising a portion of the agent 100. Translation LLM 130 comprises a pre-trained LLM configured to translate the search results, comprising a subset of data of dataset 108 responsive to input question 102, into natural language (e.g. translated search results 126). In particular, the translated search results 126 can be a natural language response to the input question 102, which comprises the search results corresponding to the subset of data queried from the dataset 108. Translation LLM 130 is provided with translation prompts for initialization. Translation prompts comprise one or more pre-defined prompts configured to initialize one or more LLMs to perform a function. Translation prompts are customized to the use case of large language model agent 100.

Each translation prompt comprises one or more pre-defined prompts configured to initialize the translation LLM 130 to generate the translated search results 126 responsive to the input question 102. In at least some embodiments, translation prompts provide translation LLM 130 with: the role of translation LLM 130, the expected output, examples of expected outputs, and rules to follow. Note that the translation prompts comprise the search results. In particular, the pre-defined prompts for the translation prompts can be generated according to one of a plurality of prompt templates. Each template can provide additional context, rules, and background to the translation LLM 130 for translating the search result. The role/task of the translation LLM 130 can be defined using a system prompt. The search results can be incorporated into the translation prompts using (e.g. by replacing) pre-defined placeholders.

The agent 100 can also comprise translation judge LLMs 119. As described above, the translation LLM 130 is configured to provide the translated search results 126 to translation judge LLMs 119. The translation judge LLMs 119 comprise one or more LLMs configured to evaluate the translated search results 126 to assess the coherency and language conciseness of the natural language translated search results 126. In at least some embodiments, translation judge LLMs 119 comprise two LLMs which, having been pre-trained using LLM training methods known to the art, are provided at least one translation judge prompt. In at least some embodiments, any one or more of the one or more LLMs of translation judge LLMs 119 may each comprise an instance of GPT-4 model of OpenAI™ initialized by one or more prompts to perform an assessment function. The LLMs comprised in the translation judge LLMs 119 can be implemented in series. In at least some embodiments, translation judge LLMs 119 comprise at least coherency LLM 120 and language conciseness LLM 122. Coherency LLM 120 and language conciseness LLM 122 each comprises a LLM, which has been initialized using a prompt of translation judge prompts. In an embodiment, coherency LLM 120 is instructed by translation judge prompts to review the translated search results 126 provided by translation LLM 130 to ensure the natural language is coherent to a user of computing device 105. In an embodiment, language conciseness LLM 122 is instructed by translation judge prompts to review the translated search results 126 provided by translation LLM 130 to ensure the natural language response is concise.

Each of the translation judge LLMs 119 provides a translation evaluation 128, being either pass (e.g. accept) or fail (e.g. reject), indicating whether the translated search results 126 comply with the necessary conditions initialized to the respective translation judge LLM by the respective translation judge prompts. In at least some embodiments, one or more of the translation judge LLMs 119 are configured to additionally provide an analysis within the translation evaluation 128 in natural language explaining why the translated search results 126 either pass or fail the evaluation of one of the one or more of the translation judge LLMs 119. In an embodiment, translation evaluation 128 must be evaluated as “pass” by each of the translation judge LLMs 119. In some embodiments, one or more (e.g. each) of the translation judge LLMs 119 can evaluate the translated search results 126 using a score. The score can comprise a part of the translation evaluation 128 and can be a numerical value in a range of values, where a threshold score is used to determine if the translated search results 126 is evaluated as a “pass” or “fail”. For example, the score can be an integer value between 1 and 10 where a score of greater than 5 is considered a passing score. The translation judge prompts can outline the scoring framework as a rule, for example by identifying the valid range of the score and the threshold score. As an example, the translation judge prompts can comprise a statement of: “rate the translated search results using a score from 1 to 10, where 10 is the best possible score and where a score of greater than 5 indicates the translated search results has passed the evaluation”.

In an embodiment, an iterative loop is formed between translation judge LLMs 119 and translation LLM 130. In at least some embodiments, if any of the translation judge LLMs 119 (e.g. coherency LLM 120, language conciseness LLM 122) returns a translation evaluation 128 of “fail”, translation LLM 130 is configured to update the translated search result and provide an updated response to translation judge LLMs 119 for further evaluation. In an embodiment, the aforementioned feedback process is iterated for pre-defined number of evaluations. The translation LLM 130 can also receive the (failure) analysis (e.g. in the translation prompts provided to the translation LLM 130) and the score generated by the translation judge LLMs 119 in order to improve the translated search results 126. In an alternative embodiment, the aforementioned feedback process is iterated until all of the translation judge LLMs 119 returns a translation evaluation 128 of “pass”.

Each translation judge prompt comprises one or more pre-defined prompts configured to initialize the translation judge LLMs 119 to evaluate the translated search results 126. In at least some embodiments, query judge prompts provide translation judge LLMs 119 with the role of translation judge LLMs 119, the expected output, examples of expected outputs, and rules to follow. The translation judge prompts can comprise the translated search results 126. In particular, the pre-defined prompts for the translation judge prompts can be generated according to one of a plurality of prompt templates. Each template can provide additional context, rules, and background to the translation judge LLMs 119 for evaluating the translated search results 126, for example with regard to the coherency and conciseness thereof, as the case may be. The role/task of the translation judge LLMs 119 can be defined using a system prompt. The translated search results 126 can be incorporated into the query judge prompt using (e.g. by replacing) pre-defined placeholders.

Large language model agent 100 provides an output of output answer 132, comprising a quantitative answer in natural language responsive to input question 102, which can be returned to the user. Specifically, the returned output answer 132 can be the translated search results 126, for example once passing the evaluations by the translation judge LLMs 119.

It should be noted that in cases where input/output of any one of the machine learning models forming the agent 100 is to be transmitted/received as an application programming interface (API) call/response, the input/output may be processed into JSON format. In at least some embodiments, the input question 102 and the output answer 132 can be transmitted to/from the agent 100 using API call/responses.

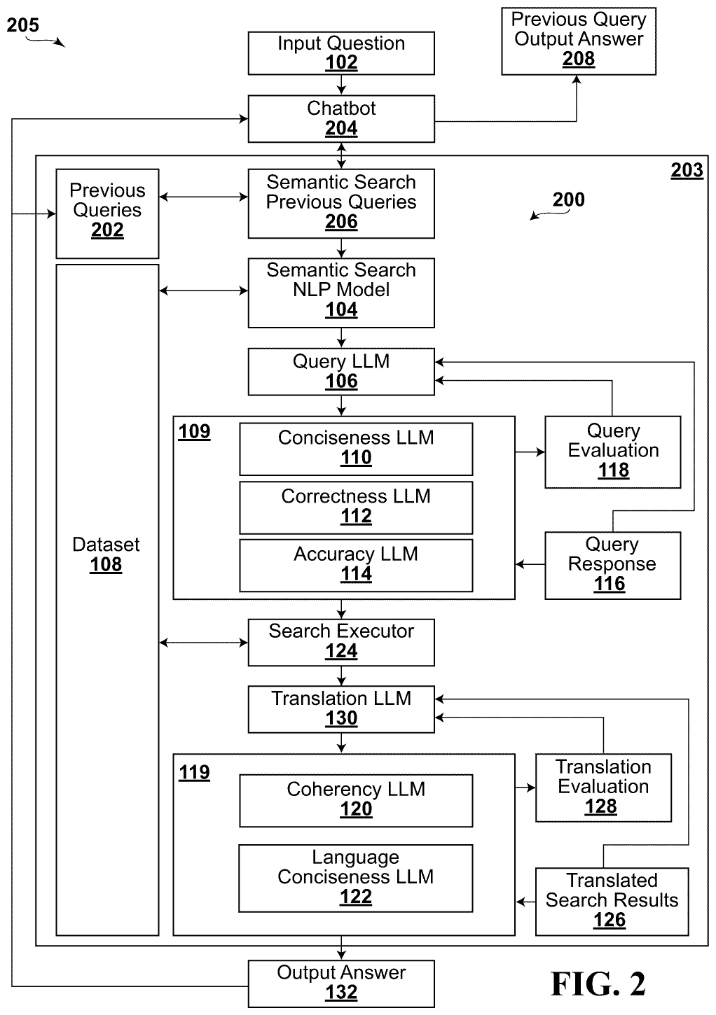

Referring now to FIG. 2, there is shown a block diagram of a computing device in which one or more technologies or methodologies can be implemented, such as, for example, analysing data and providing a natural language quantitative answer with high accuracy in response to a natural language question provided to a LLM agent. In an embodiment, the computing device includes a processor computational circuitry, and one or more large language models configured to assist in interfacing with one or more datasets.

In an embodiment, the computing device is configured to provide a large language model agent 200 in accordance with an embodiment in which the agent 200 is configured for receiving an input question 102 as input and outputs an output answer 132. It will be understood that FIG. 2 represents large language model agent 200 as data components and executable components stored within one or more storage devices 203 of a computing device 205, in accordance with an embodiment. The executable components are executable by a processor (not shown) of the computing device.

In an embodiment, a user of computing device 205 provides input question 102 to chatbot 204 (e.g. by way of a graphical user interface). Chatbot 204 is configured to provide natural language responses to inputs received from a user of computing device 205. The output answer 132 can be generated as described above with reference to FIG. 1. That is, the input questions 102 can be processed by the semantic search NLP model 104, the query LLM 106, the query judge LLMs 109, the search executor 124, the translation LLM 130, and the translation judge LLMs 119 to generate the output answer 132, as described above. The input question 102 can be stored as one of previous queries 202, for example in association with the output answer 132. The previous queries 202 (and the corresponding output answers) can be stored in a database storing past input questions (and corresponding output answers). In some embodiments, the query response 116 to the input questions 102 can also be stored. The database can be a raw data database or a vector database storing embeddings of the previous queries 202 (and the corresponding output answers). In some embodiments, the previous queries database can be an ElasticSearch™ database where embeddings of the previous queries 202 (and the corresponding output answers) are generated using the ‘.encode( )’ method.

In an embodiment, chatbot 204 is configured to provide a graphical user interface through which a user of computer system 205 can interact with large language model agent 200. In an embodiment, chatbot 204 provides input question 102 to semantic search previous queries 206. Semantic search previous queries 206 comprises a model configured to execute a semantic search of previous queries 202 using input question 102 to determine if input question 102 has been asked by a user of computer system 205 previously. In particular, the semantic search can determine if one of the previous queries 202 substantially corresponds to or is sufficiently similar to the input question 102 such that the output answer 132 of the determined previous query (comprising a subset of data from the dataset 108 that is responsive to the input question 102) is responsive to the input question 102. The model can comprise a part of the agent 200 and may be implemented as a NLP model. The semantic search can be used to determine a relationship between the input question 102 and one of the previous queries 202. In some embodiments, the semantic search can be a cosine similarity search or a KNN search. The previous queries 202 can comprise one or more output answers 132 responsive to one or more previous input question(s) 102, as described above.

According to the aforementioned embodiment, if semantic search previous queries 206 model determines previous queries 202 already contain an answer responsive to input question 102, the answer from previous queries 202 is provided to chatbot 204 which outputs previous query output answer 208 responsive to input question 102. In particular, if a query in the previous queries 202 sufficiently similar to the input question 102 is determined by the semantic search, the semantic search previous queries 206 can return the output answer corresponding to the identified query of the previous queries 202 as the output answer 132 (corresponding to previous query output answer 208). Conversely, if semantic search previous queries 206 model determines previous queries 202 does not contain an answer responsive to input question 102, semantic search previous queries 206 is configured to provide input question 102 to semantic search NLP model 104 to perform the processes as described with respect to FIG. 1 to return the output answer 132. Therefore, the agent 200 can eliminate the need to perform searches that would return a previously determined output answer 132.

In some embodiments, semantic search previous queries 206 model may determine, by performing a semantic search, that the previous queries 202 does not contain an answer responsive to input question 102 but instead contains an answer that is partially responsive to the input question 102. That is, a new query response 116 would need to be generated to perform dataset searching in accordance with the processes as described with respect to FIG. 1. For example, an input question 102 can be: “what is the price of good A and good B on day C?”. By performing the semantic search, the semantic search previous queries 206 model can determine previous queries corresponding to the questions of (1) “what is the price of good A on day C?” or (2) “what is the price of good B on day D?”. For both previous queries, the answers corresponding thereto would not sufficiently answer the input question. In particular, while the subset of data corresponding to good A and day C can be determined using the previous query in (1), the subset of data corresponding to good B and day C is not known. Similarly, while the subset of data corresponding to good B can be determined using the previous query in (2), the subset of data corresponding to good A and day C (and good B on day C) is not known. Accordingly, The semantic search can return one or more previous queries that are most similar to the input question 102 as well as the output answers corresponding thereto. The returned previous queries may be input to the query LLM 106 as semantic context for generating the query response 116. In some embodiments, the query responses and/or corresponding output answers can be additionally or alternatively input to the query LLM 106 as semantic context. These semantic context can replace or supplement the semantic context generated by the semantic search NLP model 104, as described with respect to FIG. 1. The previous queries and the corresponding output answers can provide a “warm start” for the query LLM 106 in generating an appropriate query response 116 for the input question 102 that is more likely to pass the evaluations of the query judge LLMs 109.

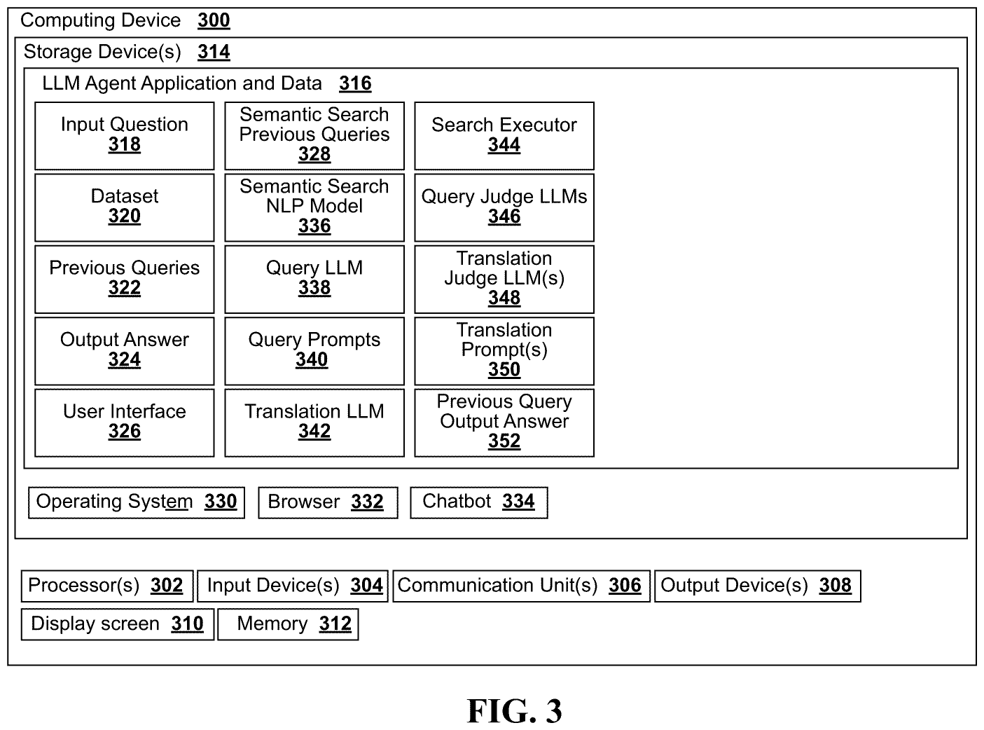

FIG. 3 depicts a block diagram of a computing device 300, in accordance with an embodiment. In the embodiment, a large language model agent in accordance with an embodiment herein is integrated with an application for implementing data search and parsing methods. Device 300 is non-limiting and is simplified for brevity.

The computing device 300 comprises one or more processors 302, one or more input devices 304, one or more communication units 306, one or more output devices 308, a display screen 310 (e.g. providing one or more graphical user interfaces), and a memory 312. Computing device 300 also includes one or more storage device(s) 314 storing one or more executable computer modules including LLM agent application and data 316 comprising: input question 318 (e.g. input question 102), dataset 320 (e.g. dataset 108), previous queries 322 (e.g. previous queries 202), output answer 324 (e.g. output answer 132), a user interface 326, semantic search previous queries 328 (e.g. search previous queries 206), semantic search NLP model 336 (e.g. semantic search NLP model 104), query LLM 338 (e.g. query LLM 106), query prompts 340, query judge prompts (not shown), translation LLM 342 (e.g. translation LLM 130), search executor 344 (e.g. search executor 124), query judge LLMs 346 (e.g. query judge LLMs 109), translation judge LLMs 348 (e.g. translation judge LLMs 119), translation prompt(s) 350, translation judge prompts (not shown), and previous query output answer 352 (e.g. previous query output answer 208). The computing device 300 may comprise additional computing modules or data stores in various embodiments. Additional computing modules and devices that may be included in various embodiments, are not shown in FIG. 3 to avoid undue complexity of the description, such as communication with one or more other computing devices, as applicable, utilizing communication unit(s) 306, for obtaining input question 318 including via a communication network (not shown).

The one or more storage device(s) 314 stores data and/or computer readable instructions for execution by a processing unit (e.g. processor(s) 302), such that when executed, the instructions cause the computing device to perform operations such as one or more methods and modules described above. The one or more storage devices 314 may take different forms and/or configurations, for example, as short-term memory or long-term memory. Storage device(s) 314 may be configured for short-term storage of information as volatile memory, which does not retain stored contents when power is removed. Volatile memory examples include random access memory (RAM), dynamic random access memory (DRAM), static random access memory (SRAM), etc. Storage device(s) 314, in some embodiments, also include one or more computer-readable storage media, for example, to store larger amounts of information than volatile memory and/or to store such information for long term, retaining information when power is removed. Non-volatile memory examples include magnetic hard discs, solid-state hard drives, optical discs, floppy discs, flash memories, or forms of electrically programmable read-only memory (EPROM) or electrically erasable and programmable read-only memory (EEPROM). Computing device 300 may store data/information (e.g. input question 318, dataset 320) to storage device(s) 314.

One or more processor(s) 302 may implement functionality and/or execute instructions within the computing device 300. For example, processor(s) 302 may be configured to receive instructions and/or data from storage device(s) 314 to execute the functionality of large language model agent(s) (e.g. 100, 200) shown in FIGS. 1 and 2, among other modules (e.g. operating system 330, browser 332, chatbot 334, etc.). Processor(s) 302 comprises one or more central processing units (e.g. CPUs), and/or graphical processing units (e.g. GPUs) having one or more processors/microprocessors, controllers/microcontrollers, etc. Other processor types may be used.

Input device(s) 304 and output device(s) 308 may include any of one or more buttons, switches, pointing devices, a keyboard, a microphone, one or more sensors, a speaker, a bell, one or more lights, etc. One or more of same may be coupled via a wired connection (e.g. Ethernet, USB A, USB C, Thunderbolt (TM of Intel Corporation)), or other communication channel.

One or more communication units 306 may communicate with external computing devices via one or more networks by transmitting and/or receiving network signals on the one or more networks. The communication units 306 may include various antennae and/or network interface cards, etc. for wireless and/or wired communications.

Display screen 310 presents images such as components of a graphical user interface. In an embodiment, display screen 310 is a touch screen device, a type of I/O device, configured to receive gestural inputs (e.g. swipes, taps, etc.) that interact with region(s) of the screen and in association with user interface components (e.g. controls) presented by an application executed by the processor(s) 302.

Storage device(s) 314 stores components of an LLM agent application and data therefor (e.g. 316). Representative components are shown. LLM agent application and data 316 comprises user interface component 326 (e.g. screens, instructions, icons, controls, etc.). User interface provides output to a user and receive input such as input for application workflow. A large language model agent (not shown) is provided as a component of LLM agent application and data 316 as previously described for providing a quantitative answer to a data-related input question (e.g. input question 318).

In an embodiment, a user can provide a data-related input question (e.g. 318) to chatbot 334 via user interface 326, which can be answered using a subset of data comprised in the dataset 320. In an embodiment, chatbot 334 provides input question 318 to semantic search previous queries 328 module, which is configured to execute a semantic search of previous queries 322, comprising a database of previous output answers responsive to one or more previous input question(s) 318. In an embodiment, data responsive to input question 318 is retrieved from previous queries 322 if such data sufficiently answers input question 318. In an embodiment, previous query output answer 352 can be displayed on display screen 310 through user interface 326. In an embodiment, if data responsive to input question 318 is not retrieved from previous queries 322, semantic search NLP model 336 executes a search of dataset 320 to provide the most relevant datasource(s) and data field(s) of a subset of data contained within dataset 320 to query LLM 338. In an embodiment, query LLM 338 is configured to receive query prompts 340 and execute a defined function to translate input question 318 from natural language to instructions (e.g. code or a syntax) receivable by the search executor 344 in order to parse the dataset 320. In an embodiment, query judge LLMs 346 are configured to receive query judge prompts and iteratively evaluate an output from query LLM 338 (e.g. the instructions to the search executor 344). In an embodiment translation judge LLM(s) 348 and translation LLM 342 are configured to receive, and be initialized by, translation prompt(s) 350, and translation judge prompts, respectively. In an embodiment, the search executor 344 is configured to search the dataset 108 in accordance with the evaluated instructions and return search results corresponding to the subset of data. In an embodiment, translation LLM 342 is configured to translate the received search results to natural language. In an embodiment, translation judge LLM(s) 348 are configured to iteratively evaluate the natural language search results (e.g. from the translation LLM 342) for at least one of: coherency, and language conciseness, for a user of computing device 300. In an embodiment, output answer 324 comprises a quantitative answer responsive to input question 318 iteratively improved by translation LLM 342 in response to one or more evaluations by translation judge LLM(s) 348. In an embodiment, output answer 324 can be displayed on display screen 310 through user interface 326 to a user of computing device 300.

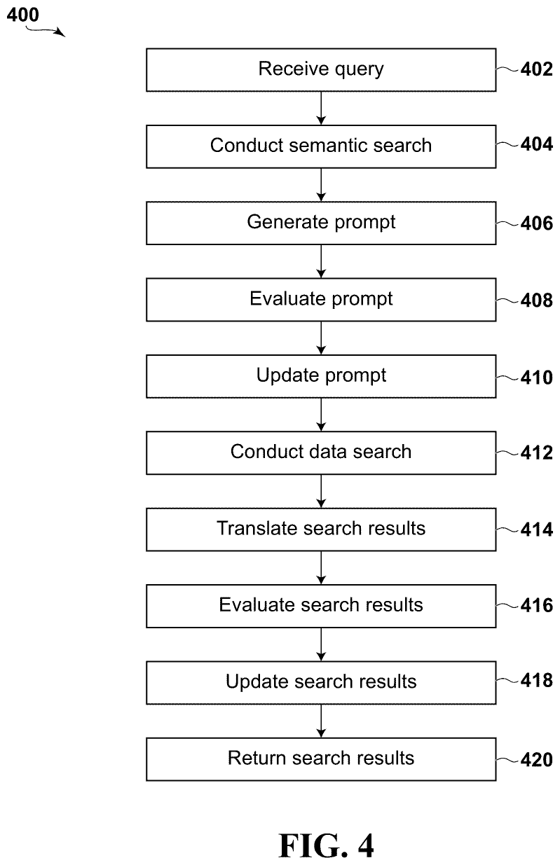

FIG. 4 depicts a method 400 for searching a dataset (e.g. dataset 108). At 402, a query is received (e.g. input question 102), for example from a user. The query can correspond to a question that can be answered using a subset of data from the dataset. At 404, a semantic context search can be conducted using the query on a vector database storing the embeddings of the dataset. The semantic context search can be performed using a NLP model (e.g. NLP model 104). The semantic context search can return semantic context for the query, for example comprising semantic context corresponding to the subset of data such as data field, description, and type thereof. The semantic context and the query can be processed by a first LLM (e.g. query LLM 106) at 406 to generate a search prompt (e.g. query response 116). The search prompt can correspond to an instruction or executable command/code for a search executor (e.g. search executor 124) to search the dataset as to return the subset of data for responding to the query. At 408, the search prompt can be evaluated by a first array of LLMs (e.g. query judge LLMs 109) to ensure that the generated search prompt can be appropriately processed by the search executor to return the appropriate subset of data. For example, the first array of LLMs can comprise a plurality of LLMs configured to evaluate the formatting and syntax of the search prompt as well as the compliance thereof to the semantic context and the query. At 410, the evaluation process can be performed iteratively to improve the search prompt to ensure that it can be successfully executed to return the subset of data. At 412, the search executor can parse the dataset using the search prompt to return the subset of data. At 414, a second LLM (e.g. translation LLM 130) can translate the search results into a natural language response (e.g. translated search results 126) to the query. At 416, the generated response can be evaluated by a second array of LLMs (e.g. translation judge LLMs 119) to ensure that the generated response is suitable for human comprehension. For example, the second array of LLMs can comprise a plurality of LLMs configured to evaluate a conciseness and coherency of the response. At 418, the evaluation process can be performed iteratively to improve the response with regard to its readability. At 420, the response is output or returned, for example to the user.

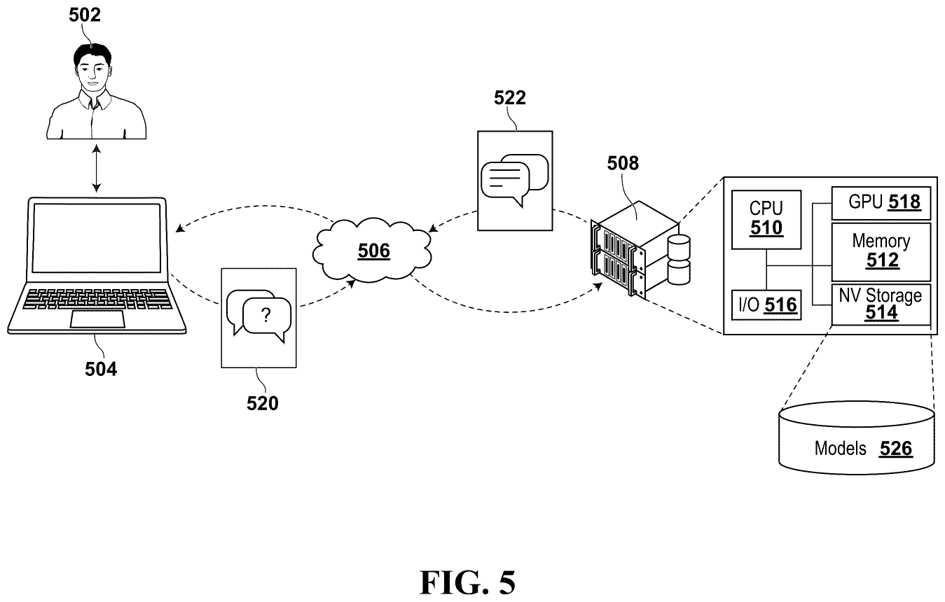

FIG. 5 depicts a system for performing dataset searching, according to an example embodiment, shown in FIG. 5 as one or more servers 508. The implementation of the servers 508 is not restrictive and servers 508 may be an on-premises server, cloud-based server, or a hybrid thereof, for example. A user 502 may interact with the servers 508 via a device 504 over a communications network 506 (e.g. the internet). The device 504 may be a computer, as depicted in FIG. 1, but is not restricted to those devices expressly shown and may be any suitable device known in the art such as smart phones and tablets. The servers 508 may provide a graphical user interface (GUI) on the device 504 for ease of communication and operation control by the user. The implementation of the GUI is not restrictive and may be, for example, a mobile/computer application or a web page. The GUI can be used to provide input to and receive output from the servers 508. Additionally or alternatively, other user interfaces, such as an audio interface that allows receipt and processing of spoken commands, and that outputs spoken narratives, may be used.

The user 502 may be interested in retrieving information using the servers 108, where the information may be retrieved by performing dataset searching. In particular, the user 502 may pose a question 520, for example as a natural language query. In response, the servers 108 may be configured to process the question 520 to return a response 522 to the question 520. The response 522 can comprise information sought by the user 502, particularly information corresponding to a subset of data comprised in one or more datasets. In particular, the question 520 may be processed by a series or array of machine learning models 526 to determine the response 522, as described above in reference to FIGS. 1-4. More specifically, the machine learnings models 526 can comprise a NLP model configured to determine a semantic context of the question 520. A first LLM comprising a portion of the machine learning models 526 can generate a dataset searching instruction corresponding to the question 520 using the semantic context (e.g. in addition to the question 520). A first array of LLMs comprising a portion of the machine learning models 526 can evaluate the generated searching instruction for compliance. A search executor such as a search algorithm or engine can execute the dataset searching using the searching instruction to return the subset of data for responding to the question 520. A second LLM comprising a portion of the machine learning models 526 can translate the subset of data into the natural language response 522. A second array of LLMs comprising a portion of the machine learning models 526 can evaluate the response 522 for readability. The evaluated response 522 can then be returned to the user 502 from the server 508 to the device 504 for display, for example over the communications network 506. Note that the machine learning models 526 may each be an artificial intelligence model or algorithm, a machine learning model or algorithm, and may comprise, in particular, a plurality of LLMs and a NLP model.

According to the present disclosure, the questions 520 may be transmitted to or retrieved by the servers 508, for example, from the device 504. The servers 508 may comprise or be coupled to one or more databases, for example one storing the questions 520 and responses 522 and/or one storing the datasets. The question 520 and the datasets may be requested, received, or accessed using an application programing interface (API) via requests/calls and responses, for example over the communications network 506, although other forms of communication such as Bluetooth and near-field communication are possible as well. In some embodiments, the machine learning models 526 may be stored on a separate server or database coupled to the servers 508. In such embodiments, the servers 508 can interact with the machine learning models 526 to process the question 520 and to generate the response 522 over the communications network 506, for example using an API.

In a particular implementation, the servers 508 each comprise a central processing unit (“CPU”) 510, a non-transitory computer-readable memory 512, non-volatile storage 514, an input/output interface 516, and a graphical processing unit (“GPU”) 518. The non-transitory computer-readable memory 512 comprises computer-executable instructions stored thereon at runtime which, when executed by the CPU 510, configure the server to perform the herein described processes of performing dataset searching to generate the response 522. The non-volatile storage 514 has stored on it computer-executable instructions that are loaded into the non-transitory computer-readable memory 512 at runtime. The input/output interface 516 allows the server to communicate with one or more external devices such as the device 504 (e.g. via network 506). The non-transitory computer-readable memory 512 may also have stored thereon the machine learning models 526. The GPU 518 may be used to control a display and may be used to process the question 520 to generate the response 522. The servers 508 and the device 504 may each provide a communications interface which allows software and data to be transferred, for example between the servers 508 and the device 504 over the communications network 506.

The CPU 510 and GPU 518 may be one or more processors or microprocessors, which are examples of suitable processing units, which may additionally or alternatively comprise an artificial intelligence accelerator, programmable logic controller, a microcontroller (which comprises both a processing unit and a non-transitory computer readable medium), neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

It should be noted that while FIG. 1 depicts the device 504 and the servers 508 as separate entities coupled over the communication network 506, the device 504 and servers 508 may also be coupled directly/physically using cable(s) for data transfer. In some embodiments, the servers 508 may also be the device 504 or comprise the device 504 (e.g. the servers 508 being implemented as a part of a computer system). In such an embodiment, the question 520 can be directly processed by the servers 508.

The term “computer system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference to “a LLM” or “the LLM” does not exclude embodiments in which multiple LLMs are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means A, B, C, A and B, A and C, B and C, or A, B, and C.

It is contemplated that any part of any aspect or embodiment discussed in this specification can be implemented or combined with any part of any other aspect or embodiment discussed in this specification, so long as such implementation or combination is not performed using mutually exclusive parts.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

1. A dataset searching method, comprising:
(a) receiving a query for retrieving information, wherein the information corresponds to a subset of data comprised in a dataset;
(b) generating a response to the query comprising the information retrieved from the dataset using a plurality of machine learning models;
(c) wherein the generating comprises:
(i) processing the query to generate an instruction for parsing the dataset;
(ii) parsing the database according to the instruction to return the information; and
(iii) generating the response using the information;
(d) wherein the plurality of machine learning models are respectively configured to:
(i) generate the instruction according to the query;
(ii) evaluate the instruction;
(iii) generate the response from the information; and
(iv) evaluate the response.

2. The method of claim 1,
(a) wherein the plurality of machine learning models comprises:
(i) a first large language model (LLM) configured to generate the instruction according to the query;
(ii) a first array of LLMs configured to evaluate the instruction;
(iii) a second LLM configured to generate the response form the information; and
(iv) a second array of LLMs configured to evaluate the response; and
(b) wherein the parsing comprises processing the instruction using a search executor configured to search the dataset to return the information.

3. The method of claim 2,
(a) wherein the query is a natural language query, and
(b) wherein the processing comprises determining semantic context in the query, the semantic context corresponding to a relationship between the query and the data comprised in the dataset.

4. The method of claim 3, wherein the semantic context comprises a data field of the subset of data, a data type of the subset of data, a data source of the subset of data, a description of the subset of data, or combinations thereof.

5. The method of claim 3, wherein the plurality of machine learning models further comprises a natural language processing (NLP) model configured to determine the semantic context.

6. The method of claim 3, wherein the determining comprises:
(a) performing a K-nearest neighbor search on embeddings of the dataset.

7. The method of claim 6, further comprising:
(a) generating the embeddings from the dataset.

8. The method of claim 3, wherein the generating of the instruction comprises inputting the semantic context to the first LLM.

9. The method of claim 8, wherein the instruction is generated according to a template comprising: placeholders for the semantic context, a system prompt for the first LLM corresponding to the instruction, rules for the instruction, context for the instruction, background for the instruction, or combinations thereof.

10. The method of claim 2, wherein the first array of LLMs comprises a formatting LLM configured to evaluate a format of the instruction, a correctness LLM configured to evaluate a syntax of the instruction and an alignment of the instruction to the query, an accuracy LLM configured to evaluate a compliance of the instruction to semantic context, or combinations thereof.

11. The method of claim 2,
(a) wherein the evaluating of the instruction comprises processing the instruction using each LLM in the first array of LLMs, wherein each LLM either accepts or rejects the instruction;
(b) wherein rejecting the instruction comprises outputting, by a corresponding LLM in the first array of LLMs, one or more reasons for rejecting the instruction; and
(c) wherein the generating of the instruction further comprises iteratively generating the instruction until each LLM in the first array of LLMs accepts the instruction, wherein each successive instruction is generated by the first LLM according to the one or more reasons for rejecting the instruction.

12. The method of claim 2,
(a) wherein the first array of LLMs is implemented using LangChain and inherits the StringEvaluator class; and
(b) wherein the search executor is an ElasticSearch executor.

13. The method of claim 2,
(a) wherein the instruction is generated as computer readable search string code compatible with a search executor configured to search the dataset by the first LLM; and
(b) wherein the parsing comprises: processing the instruction using the search executor to parse the dataset to retrieve the information corresponding to the subset of data.

14. The method of claim 13,
(a) wherein the subset of data is translated into the response by the second LLM; and
(b) wherein the response is a natural language response to the query comprising the subset of data.

15. The method of claim 2, wherein the second array of LLMs comprises a coherency LLM configured to evaluate natural language coherency of the response, a conciseness LLM configured to evaluate natural language conciseness of the response, or both.

16. The method of claim 2,
(a) wherein the evaluating of the response comprises processing the response using each LLM in the second array of LLMs, wherein each LLM either accepts or rejects the response;
(b) wherein rejecting the response comprises outputting, by a corresponding LLM in the second array of LLMs, one or more reasons for rejecting the response; and
(c) wherein the generating of the information further comprises iteratively generating the response until each LLM in the second array of LLMs accepts the response, wherein each successive response is generated by the second LLM according to the one or more reasons for rejecting the response.

17. The method of claim 1, further comprising:
(a) storing the query and the response as embeddings in a vector database storing a plurality of queries and a plurality of responses corresponding thereto;
(b) receiving a second query for retrieving second information;
(c) performing a semantic context search of the second query on the plurality of responses stored in the vector database using a NLP model to determine a relevant query from the plurality of queries for retrieving the second information; and
(d) returning a second response corresponding to the relevant query.

18. The method of claim 1, wherein the query is received via an application programming interface or a textual chat interface.

19. A system for performing dataset searching, the system comprising at least one processing unit configured to perform a dataset searching method, the method comprising:
(a) receiving a query for retrieving information, wherein the information corresponds to a subset of data comprised in a dataset;
(b) generating a response to the query comprising the information retrieved from the dataset using a plurality of machine learning models;
(c) wherein the generating comprises:
(i) processing the query to generate an instruction for parsing the dataset;
(ii) parsing the database according to the instruction to return the information; and
(iii) generating the response using the information;
(d) wherein the plurality of machine learning models are respectively configured to:
(i) generate the instruction according to the query;
(ii) evaluate the instruction;
(iii) generate the response from the information; and
(iv) evaluate the response.

20. At least one non-transitory computer readable medium having stored thereon computer instruction, which, when executed by at least one processor causes the at least one processor to perform a dataset searching method, the method comprising:
(a) receiving a query for retrieving information, wherein the information corresponds to a subset of data comprised in a dataset;
(b) generating a response to the query comprising the information retrieved from the dataset using a plurality of machine learning models;
(c) wherein the generating comprises:
(i) processing the query to generate an instruction for parsing the dataset;
(ii) parsing the database according to the instruction to return the information; and
(iii) generating the response using the information;
(d) wherein the plurality of machine learning models are respectively configured to:
(i) generate the instruction according to the query;
(ii) evaluate the instruction;
(iii) generate the response from the information; and
(iv) evaluate the response.
